(19) United States
(12) Patent Application Publication
(10) Pub. No.: US 2025/0182746 A1
(43) Pub. Date: Jun. 5, 2025

(54) METHOD, DEVICE AND MEDIUM FOR DETECTING KEY SEGMENTS IN AUDIO OR VIDEO

(71) Applicants: Beijing Zitiao Network Technology Co., Ltd., Beijing (CN); Lemon Inc., Grand Cayman (KY)

(72) Inventors: Keyu Chen, Beijing (CN); Lelai Deng, Beijing (CN); Ziheng Liu, Beijing (CN); Qian Lv, Beijing (CN); Jiaqi Song, Beijing (CN); Shizhu Liu, Los Angeles, CA (US)

(21) Appl. No.: 18/967,968

(22) Filed: Dec. 4, 2024

(30) Foreign Application Priority Data
Dec. 5, 2023 (CN) 202311660482.9

(51) Int. Cl. G10L 15/08; G06V 20/40; G10L 15/02; G10L 25/57

(52) U.S. Cl. CPC G10L 15/08; G06V 20/46; G10L 15/02; G10L 25/57; G10L 2015/088

(57) ABSTRACT

The present disclosure provides a method, a device, a computer-readable storage medium, and a computer program product for detecting key segments in an audio or video. The method includes: obtaining multi-modal features of an audio or video, where the multi-modal features include a visual feature, an acoustic feature, and a natural language feature; determining candidate key segments in the audio or video based on the multi-modal features; obtaining a keyword list based on automatic speech recognition (ASR) text of the candidate key segments; and determining a key segment in the audio or video based on the keyword list.

### CROSS-REFERENCE TO RELATED APPLICATION(S)

This application claims priority to Chinese Patent Application No. 202311660482.9, filed with the China National Intellectual Property Administration on Dec. 5, 2023, the disclosure which is incorporated by reference in its entirety.

### FIELD

The present disclosure relates to the field of audio and video technologies, and more specifically, to a method, a device, and a computer-readable storage medium, and a computer program product for detecting key segments in an audio or video.

### BACKGROUND

With the rapid development of current short video technologies, a user often needs to add subtitles to a video, and at the same time, expects to apply differentiated subtitle styles to some key subtitle segments to increase the richness of the video.

### SUMMARY

In view of this, the present disclosure provides a method, a system, a computing device, a computer-readable storage medium, and a computer program product for detecting key segments in an audio or video.

According to a first aspect of the present disclosure, a method for detecting key segments in an audio or video is provided, including: obtaining multi-modal features of an audio or video, where the multi-modal features include a visual feature, an acoustic feature, and a natural language feature; determining candidate key segments in the audio or video based on the multi-modal features; obtaining a keyword list based on automatic speech recognition (ASR) text of the candidate key segments; and determining a key segment in the audio or video based on the keyword list.

According to a second aspect of the present disclosure, a system for detecting key segments in an audio or video is provided, including: a feature extraction unit configured to obtain multi-modal features of an audio or video, where the multi-modal features includes a visual feature, an acoustic feature, and a natural language feature; a candidate key segment recognition unit configured to determine candidate key segments in the audio or video based on the multi-modal features; a keyword list obtaining unit configured to obtain a keyword list based on automatic speech recognition (ASR) text of the candidate key segments; and a key segment obtaining unit configured to determine a key segment in the audio or video based on the keyword list.

According to a third aspect of the present disclosure, a computing device is provided, including: at least one processing unit; and at least one memory, where the at least one memory is coupled to the at least one processing unit and stores instructions executable by the at least one processing unit, and the instructions, when executed by the at least one processing unit, cause the computing device to perform the method according to the first aspect of the present disclosure.

According to a fourth aspect of the present disclosure, a non-transitory computer storage medium is provided, including machine-executable instructions that, when executed by a device, cause the device to perform the method according to the first aspect of the present disclosure.

According to a fifth aspect of the present disclosure, a computer program product is provided, including machine-executable instructions that, when executed by a device, cause the device to perform the method according to the first aspect of the present disclosure.

It should be understood that the content described in the summary is neither intended to identify key or essential features of embodiments of the present disclosure, nor is it intended to limit the scope of the present disclosure. Other features of the present disclosure will be readily understood from the following description.

### BRIEF DESCRIPTION OF THE DRAWINGS

The above and other objectives, features, and advantages of embodiments of the present disclosure will be easier to understand with reference to the following detailed description of the accompanying drawings. In the accompanying drawings, a plurality of embodiments of the present disclosure will be described in an exemplary and non-limiting manner, in which:

FIG. 1 is a block diagram of a computing device capable of implementing some embodiments of the present disclosure;

FIG. 2 is a schematic block diagram of a framework of a key segment detector according to some embodiments of the present disclosure;

FIG. 3 is a schematic flowchart of a method for detecting key segments in an audio or video according to some embodiments of the present disclosure;

FIG. 4 is a schematic diagram of a keyword list obtaining unit according to an embodiment of the present disclosure;

FIG. 5A is a schematic diagram of an audio or video input page for detecting key segments in an audio or video according to some embodiments of the present disclosure;

FIG. 5B is a schematic diagram of a highlighted output result of detecting key segments in an audio or video according to an embodiment of the present disclosure; and

FIG. 6 is a schematic block diagram of an apparatus for detecting key segments in an audio or video according to some embodiments of the present disclosure.

### DETAILED DESCRIPTION OF EMBODIMENTS

The concepts of the present disclosure will now be described with reference to various exemplary embodiments shown in the accompanying drawings. It should be understood that the descriptions of these embodiments are only for enabling those skilled in the art to better understand and further implement the present disclosure, and are not intended to limit the scope of the present disclosure in any manner. It should be noted that similar or identical reference numbers may be used in the drawings where feasible, and the similar or identical reference numbers may represent similar or identical elements. Those skilled in the art will understand that from the following description, alternative embodiments of structures and/or methods described herein may be adopted without departing from the principles and concepts of the disclosure as described.

In the context of the present disclosure, the term “including/comprising” and its variants may be understood as an open-ended term, which means “including but not limited to”. The term “based on” may be understood as “at least partially based on”. The term “an embodiment” or “the embodiment” may be understood as “at least one embodiment”. The term “another embodiment” may be understood as “at least one other embodiment”. Other terms that may appear but are not mentioned herein should not be interpreted or defined in a manner that is contrary to the concept on which the embodiments of the present disclosure are based, unless explicitly stated.

With the development of short video technologies, a user often needs to add subtitles to a video, and expects to apply different subtitle styles to key subtitle segments, to increase the richness and attractiveness of the video. Currently, a mainstream procedure of detecting a key segment in an audio or video is as follows: After manually adding subtitles, the user needs to review content of the video one by one, manually select a key segment based on personal preferences and subtitle content, and modify a corresponding subtitle style. Such a method is low in efficiency and high in costs, and most users lack the capability of identifying a key segment in an audio or video and controlling a frequency.

To solve or alleviate the above problem and/or other potential problems, embodiments of the present disclosure provide a method for detecting key segments in an audio or video. In this method, multi-modal features of an audio or video are extracted, and the multi-modal features are separately analyzed to obtain candidate key segments, and filtering is further performed based on automatic speech recognition (ASR) text of the candidate key segments to determine a final key segment. In this way, the key segment in the audio or video can be automatically detected, thereby reducing costs for a user to manually add subtitles and select the key segment, and having a better capability of identifying a key segment than selecting a key segment by the user based on personal preferences.

Basic principle and implementations of the present disclosure are illustrated below with reference to the accompanying drawings. It should be understood that exemplary embodiments are given only to enable those skilled in the art to better understand and thus implement the embodiments of the present disclosure, and are not intended to limit the scope of the present disclosure in any manner.

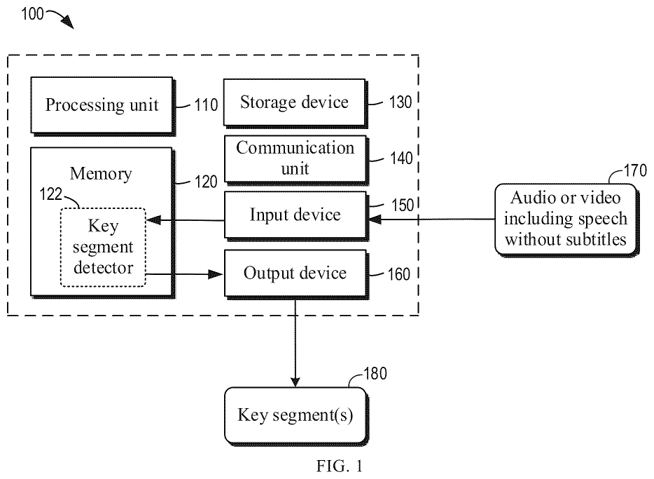

FIG. 1 is a block diagram of a computing device 100 capable of implementing a plurality of embodiments of the present disclosure. It should be understood that the computing device 100 shown in FIG. 1 is merely an example and should not constitute any limitation on the functions and scopes of the implementations described in the present disclosure. As shown in FIG. 1, components of the computing device 100 may include but are not limited to one or more processors or processing units 110, a memory 120, a storage device 130, one or more communication units 140, one or more input devices 150, and one or more output devices 160.

In some implementations, the computing device 100 may be implemented as various user terminals or service terminals with a computing capability. The service terminals may be servers, large computing devices, and the like provided by various service providers. The user terminals, such as any type of mobile terminal, fixed terminal, or portable terminal, include mobile phones, stations, units, devices, multimedia computers, multimedia tablets, Internet nodes, communicators, desktop computers, laptop computers, notebook computers, netbook computers, tablet computers, personal communication system (PCS) devices, personal navigation devices, personal digital assistants (PDA), audio/video players, digital cameras/camcorders, positioning devices, television receivers, radio receivers, e-book devices, game devices, or any combination thereof, including accessories and peripherals of these devices or any combination thereof. It is also predictable that the computing device 100 can support any type of user-oriented interface (such as a “wearable” circuit).

The processing unit 110 may be a physical or virtual processor, and can perform various processing based on a program stored in the memory 120. In a multi-processor system, a plurality of processing units execute computer-executable instructions in parallel, to improve a parallel processing capability of the computing device 100. The processing unit 110 may also be referred to as a central processing unit (CPU), a graphics processing unit (GPU), a microprocessor, a controller, and a microcontroller.

The computing device 100 generally includes a plurality of computer storage media. Such media may be any available media accessible by the computing device 100, including, but not limited to, volatile and non-volatile media and removable and non-removable media. The memory 120 may be a volatile memory (for example, a register, a cache, or a random-access memory (RAM)), a non-volatile memory (for example, a read-only memory (ROM), an electrically erasable programmable read-only memory (EEPROM), or a flash memory), or a specific combination thereof. The memory 120 may include a key segment detector 122 that is implemented as a program module. The key segment detector 122 may be configured as a program module that performs a function of detecting a key segment in an audio or video described herein. The key segment detector 122 may be accessed and operated by the processing unit 110 to implement a corresponding function.

The storage device 130 may be a removable or non-removable medium, and may include a machine-readable medium, which can be used to store information and/or data and can be accessed in the computing device 100. The computing device 100 may further include other removable/non-removable and volatile/non-volatile storage media. Although not shown in FIG. 1, a disk drive for reading from or writing into removable and non-volatile disks and an optical disc drive for reading from or writing into removable and non-volatile optical discs may be provided. In these cases, each drive may be connected to a bus (not shown) through one or more data medium interfaces.

The communication unit 140 implements communication with another computing device through a communication medium. In addition, functions of the components of the computing device 100 may be implemented by a single computing cluster or a plurality of computing machines, and these computing machines can communicate through a communication connection. Therefore, the computing device 100 may perform operations in a networked environment through a logical connection to one or more other servers, a personal computer (PC), or another general network node.

The input device 150 may be one or more input devices, such as a mouse, a keyboard, a trackball, a touchscreen, and a speech input device. The output device 160 may be one or more output devices, such as a display, a speaker, and a printer. The computing device 100 may further communicate, through the communication unit 140 as required, with one or more external devices (not shown), for example, a storage device and a display device, with one or more devices enabling a user to interact with the computing device 100, or with any device (for example, a network interface card or a modem) enabling the computing device 100 to communicate with one or more other computing devices. Such communication may be performed through an input/output (I/O) interface (not shown).

In some implementations, in addition to being integrated on a single device, some or all of the components of the computing device 100 may also be disposed in a form of a cloud computing architecture. In the cloud computing architecture, these components may be arranged remotely, and may work together to implement the functions described in the present disclosure. In some implementations, cloud computing provides computing, software, and data access and storage services, which do not require an end user to be aware of a physical location or configuration of a system or hardware providing these services. In various implementations, the cloud computing provides the services over a wide area network (such as the Internet) using an appropriate protocol. For example, cloud computing providers offer applications over the wide area network, which may be accessed through a web browser or any other computing component. Software or components of the cloud computing architecture and corresponding data may be stored on servers at remote locations. Computing resources in a cloud computing environment may be consolidated at a remote data center, or may be decentralized. Cloud computing infrastructures may provide services through a shared data center, even though they appear as a single access point to users. Therefore, the components and functions described herein may be provided from service providers at remote locations by using the cloud computing architecture. Alternatively, the components and functions may be provided from a conventional server, or may be installed directly or otherwise on a client device.

The computing device 100 may detect a key segment in an audio or video based on various implementations of the present disclosure. As shown in FIG. 1, the computing device 100 may receive an audio or video 170 through the input device 150. The audio or video 170 may be provided by a user, and may include speech without subtitles. Alternatively, the computing device 100 may read the audio or video 170 from the storage device 130, or receive the audio or video 170 from another device (for example, a mobile phone, a tablet computer, or a personal computer) through the communication unit 140. The computing device 100 may transmit the audio or video 170 to the key segment detector 122. The key segment detector 122 detects key segment(s) 180 in the audio or video 170 based on the audio or video. Differentiated subtitle styles are applied to the detected key segment(s) 180 during generation of subtitles, so that the richness of the video is increased.

For example, the audio or video 170 is a cooking demonstration video that is recorded by a user but has no subtitles, and may be a video in different languages, such as English or Chinese. Correspondingly, the key segment(s) 180 detected by the key segment detector 122 based on the audio or video 170 may include key information content of the video, and has an appropriate key segment frequency. When the audio or video 170 is another video including speech and without subtitles, the key segment(s) 180 can also include key information content of the video, and is not limited to a specific audio or video.

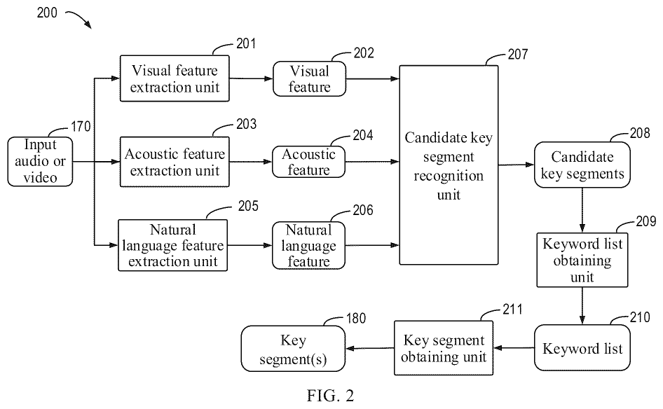

The technical solution described above is for example only, and is not intended to limit the present invention. To explain the principle of the above solution more clearly, a process of detecting the key segment(s) 180 based on the video 170 will be described in more detail with reference to FIG. 2.

FIG. 2 is a schematic block diagram of a framework of a key segment detector 200 according to an embodiment of the present disclosure. The key segment detector 200 is an example implementation of the key segment detector 122 in FIG. 1. It should be noted that the key segment detector 200 shown in FIG. 2 is merely illustrative, the key segment detector 200 may also be implemented by using a different system or framework. For example, some modules can be omitted or changed, and are not limited to the framework shown in FIG. 2.

As shown in FIG. 2, the key segment detector 200 may receive an audio or video 170 input by a user. The input audio or video 170 may be a video including speech without subtitles, for example, a cooking demonstration video that is recorded by the user using a mobile phone. In some embodiments, the key segment detector 200 may separately extract a visual feature 202 in the audio or video 170 by using a visual feature extraction unit 201, extract an acoustic feature 204 in the audio or video 170 by using an acoustic feature extraction unit 203, and extract a natural language feature 206 in the audio or video 170 by using a natural language feature extraction unit 205.

In some embodiments, the visual feature extraction unit 201 may extract the visual feature 202 in the audio or video 170 by using an object detection technology in the field of computer vision (CV). A basic procedure of object detection includes: finding an object of interest in an image of the audio or video 170, determining a category of the object, and outputting a corresponding coordinate position, that is, recognition and positioning. The visual feature 202 includes a picture feature from a visual perspective. Optionally, the picture feature may be a color feature, a shape feature, a motion feature, or the like.

In some embodiments, the acoustic feature extraction unit 203 may extract the acoustic feature 204 in the audio or video 170 by using an audio event detection (AED) (or interchangeably, sound event detection, SED) technology. The acoustic feature 204 may be a specific audio event. The specific audio event, such as applause, laughter, or whomp, in the audio or video 170 can be identified and classified through AED. Optionally, the AED may be performed based on mel-frequency cepstral coefficients (MFCC), and a characteristic that a human auditory system can be simulated through MFCC is used to detect and recognize the audio event. Optionally, the AED may alternatively be performed based on filter banks (Fbanks), and a sound signal is analyzed and processed by using the filter banks to detect and recognize the audio event.

In some embodiments, the natural language feature extraction unit 205 may extract the natural language feature 206 in the audio or video 170 by using a natural language processing (NLP) technology. Optionally, a highlighting segment in ASR text corresponding to audio in the audio or video 170 may be detected based on a knowledge graph (KG) and a pre-trained text detection model using a transformer-based bidirectional encoder representation technology (BERT).

As shown in the figure, the visual feature 202, the acoustic feature 204, and the natural language feature 206 extracted from the audio or video 170 may be provided to a candidate key segment recognition unit 207. In some embodiments, the input multi-modal features may be classified and scored by a multi-modal key segment classifier.

The multi-modal key segment classifier is a classifier that can process multi-modal data at the same time, and can classify different types of information such as audio, videos, and text by using a technology such as a convolutional neural network (CNN) or a recurrent neural network (RNN), and score each sample based on a feature of each mode and interactions between the modes, to evaluate the quality, the similarity, or the relevance of the sample. The candidate key segment recognition unit 207 may determine, in response to scoring results exceeding a threshold, a plurality of key segments that may include key information, and further remove audio or video segments without ASR text through further filtering, thereby obtaining candidate key segments 208.

As shown in the figure, the candidate key segments 208 may be provided to a keyword list obtaining unit 209. In some embodiments, the keyword list obtaining unit 209 may extract candidate keywords from ASR text of the candidate key segments 208 by using a recall algorithm. The recall algorithm is a method of selecting an item related to a user need from a large number of candidate items. Optionally, the candidate keywords may be recalled based on a pre-trained deep learning model, or the candidate keywords may be recalled based on a predefined vocabulary or dictionary, or the candidate keywords may be recalled by analyzing a data pattern.

In some embodiments, the keyword list obtaining unit 209 may obtain a keyword list 210 by ranking the candidate keywords. For example, if the audio or video 170 is recognized as a subject “travel”, first, candidate keywords belonging to a travel label of a first priority are determined as keywords; if a quantity of keywords belonging to the travel label cannot meet a keyword frequency in a unit time interval, candidate keywords belonging to a label (for example, food) of a second priority are determined as keywords; and if a quantity of the keywords is still not enough, candidate keywords belonging to a label (for example, photography) of a next-level priority are determined as keywords, and so on, until a quantity of keywords in the unit time interval meets a keyword frequency condition.

Optionally, a subject of the audio or video 170 and labels of the candidate key segments 208 may be obtained via the multi-modal key segment classifier. Optionally, priorities of the labels may be obtained from the knowledge graph. The knowledge graph includes an entity and a corresponding label and specifies a label priority. Optionally, the label priority may be obtained through data statistics and machine learning. In some embodiments, the label priority may be user-defined.

As shown in the figure, the keyword list 210 may be provided to the key segment obtaining unit 211 to obtain the key segment(s) 180. A keyword in the keyword list 210 has associated timestamp information. Therefore, the key segment obtaining unit 211 may locate a corresponding time interval list based on the keyword list 210, to obtain the corresponding key segment(s) 180.

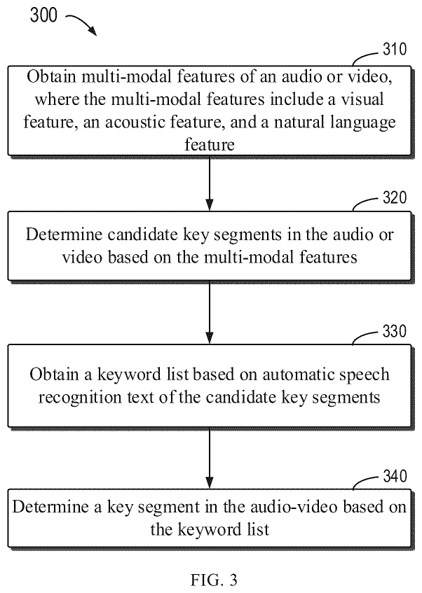

FIG. 3 is a schematic flowchart of a method 300 for detecting key segment(s) in an audio or video according to some embodiments of the present disclosure. In some embodiments, the method 300 may be implemented by, for example, the computing device 100 shown in FIG. 1. More specifically, the method 300 may be implemented by the key segment detector 122 in FIG. 1. It should be understood that the method 300 may further include additional actions not shown and/or may omit actions shown, and the scope of the present disclosure is not limited in this regard. For ease of description, the method 300 is described with reference to the framework shown in FIG. 2.

As shown in FIG. 3, in block 310, the computing device 100 obtains multi-modal features of an audio or video, where the multi-modal features include a visual feature 202, an acoustic feature 204, and a natural language feature 205. In some embodiments, the computing device 100 may be a local device such as a mobile phone, and a user may operate in an application (APP) to input an audio or video. In some embodiments, the computing device 100 may be a server on the Internet, such as, a cloud server, and receives, via a network, an audio or video transmitted from a mobile phone of the user.

In some embodiments, the computing device 100 may extract the visual feature 202 in the audio or video 170 through object detection, and the visual feature 202 may include a picture feature of the audio or video 170. Optionally, the picture feature may be a color feature, a shape feature, a motion feature, or the like. In some embodiments, the computing device 100 may extract the acoustic feature 204 in the audio or video 170 by using the acoustic feature extraction unit 203, and the acoustic feature 204 includes an audio event, such as applause or laughter. In some embodiments, the computing device 100 may extract the natural language feature 205 in the audio or video 170 based on a knowledge graph and a pre-trained text detection model, and the natural language feature 206 includes ASR text.

As shown in FIG. 3, in block 320, the computing device 100 determines candidate key segments 208 in the audio or video based on the multi-modal features. In some embodiments, the computing device 100 may classify and score the multi-modal features through a multi-modal key segment classifier, and determine, in response to a scoring results exceeding a threshold, a timestamp of a segment including key information, to determine a plurality of segments including the key information in the audio or video 170. Subsequently, the computing device 100 may recognize ASR text of these segments, and filter out segments without ASR text from these segments, to obtain the candidate key segments 208. The segment(s) without ASR text refers to a segment that does not include speech information, and therefore, there is no need to generate subtitles and a corresponding key segment for the segment. In some embodiments, the computing device 100 may further obtain a subject category label of the audio or video 170 and labels of the candidate key segments based on an output result of the multi-modal key segment classifier and the knowledge graph.

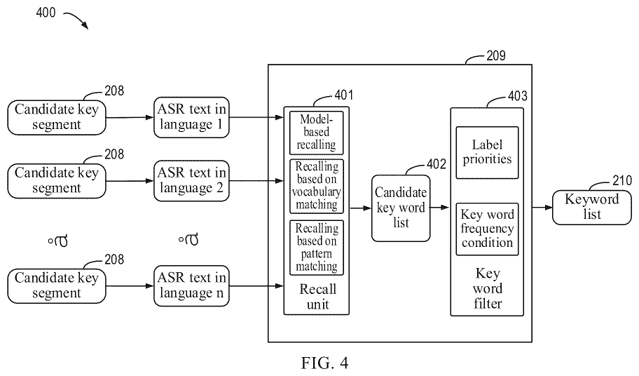

As shown in FIG. 3, in block 330, the computing device 100 may obtain a keyword list 210 based on the ASR text of the candidate key segments 208. In some embodiments, the computing device 100 may extract candidate keywords based on the ASR text, and then rank the candidate keywords based on labels of the candidate segments related to a knowledge graph, to determine the keyword list 210. A process of obtaining the keyword list 210 is described in more detail below with reference to FIG. 4.

FIG. 4 is a schematic diagram of a keyword list obtaining unit 400 according to an embodiment of the present disclosure. The keyword list obtaining unit 400 may be an example implementation of the keyword list obtaining unit 209 shown in FIG. 2. In some embodiments, as shown in FIG. 4, the ASR text and languages corresponding to the candidate key segments 208 (for example, obtained by using the natural language feature extraction unit 205) may be provided to a recall unit 401 in the keyword list obtaining unit 209 to obtain a candidate keyword list 402, and then may be filtered by using a keyword filter 403 to obtain the keyword list 210.

There are many ways to identify the candidate keywords. In some embodiments, the recalling may include model-based recalling. For example, the recall unit 401 may identify the candidate keywords through a pre-trained deep learning model based on semantic information of the ASR text. Additionally or alternatively, the recalling may include recalling based on vocabulary matching. The recall unit 401 may identify the candidate keywords by querying a predefined vocabulary or dictionary for matching, and determine words appearing in the vocabulary or dictionary as the candidate keywords. The vocabulary and the dictionary may be obtained based on the knowledge graph. Additionally or alternatively, the recalling may further include recalling based on pattern matching. The recall unit 401 may recall the candidate keyword list 402 by identifying a data pattern or structure from large-scale data for matching. For example, information such as time and a location may be determined as the candidate keywords. It should be noted that the above recalling methods can be combined in any manner. This is not limited in the present disclosure.

The candidate keyword list 402 is further provided to the keyword filter 403. The keyword filter 403 may be configured with a label priority and a keyword frequency condition. In some embodiments, the keyword filter 403 may rank the candidate keyword list 402 based on labels of the candidate key segments 208 in which the candidate keywords are located and label priorities. As mentioned above, the labels of the candidate key segments 208 may be obtained by a multi-modal key segment classifier. The label priority may be determined based on the knowledge graph, and the knowledge graph may be a vertical knowledge graph in a specific field (for example, food, agriculture, or travel). In the label priorities, a label of a subject of the current audio or video may be in a first priority, and a label with a lower priority may be determined based on a relationship (for example, a child label, a parent label, or a brother label) between labels in the knowledge graph and a distance between the labels.

The keyword filter 403 may further filter the ranked candidate keyword list 402 based on the keyword frequency condition, to determine the keyword list 210. The keyword frequency condition specifies a maximum allowed number or proportion of keywords in a time interval. The keyword filter 403 first sets the label of the subject of the audio or video 170 to a label of the first priority, uses this label as a target label, and then determines candidate keywords belonging to the target label as keywords. If the keyword frequency condition is not met in this case, the keyword filter 403 uses a label of a secondary priority that is a lower level as a target label, and determines candidate keywords belonging to the current target label as keywords. The rest can be done in the same manner until the keyword frequency condition is met. Finally, the keyword list 210 is obtained.

Return to FIG. 3. In block 340, the computing device 100 may determine a key segment in the audio or video based on the keyword list. Referring to FIG. 2, the keyword list 210 may be provided to the key segment obtaining unit 211. The key segment obtaining unit 211 may locate a time interval list of the final key segment 180 based on timestamps of keywords in the keyword list 210, to obtain the key segment 180. In some embodiments, prompt information may be sent to the user when the key segment 180 is being played, for example, to display the corresponding keywords in a specific style. In some implementations, the style may be related to a label of the keyword or the key segment. For example, different styles are applied based on the label priorities. In some implementations, the user may adjust the style based on needs.

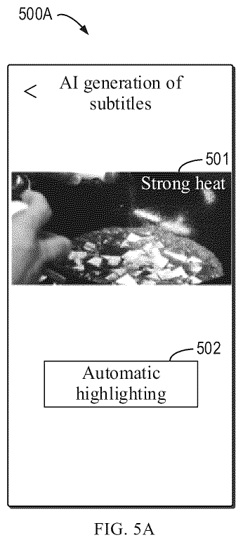

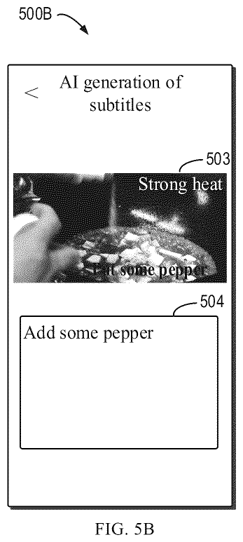

FIG. 5A and FIG. 5B show a user interaction process for automatically detecting key segment(s) in an audio or video according to some embodiments of the present disclosure. FIG. 5A is a schematic diagram of an audio or video input page 500A for detecting key segment(s) in an audio or video according to some embodiments of the present disclosure. The audio or video input page 500A includes an input audio or video 501 and an automatic highlighting control 502. The input audio or video 501 may be a video including speech without subtitles. As shown in FIG. 5A, the audio or video 501 input by the user may be a video without subtitles, and demonstrates a method for cooking Mapo Tofu. After uploading the audio or video, the user may tap the automatic highlighting control 502, to enter a highlighting output result page 500B, and obtain a subtitled video and subtitles with a highlighted keyword.

FIG. 5B is a schematic diagram of a highlighted output result page 500B of detecting key segments in an audio or video according to some embodiments of the present disclosure. The highlighted output result page 500B includes a generated subtitled audio or video 503 and real-time subtitles 504 with a highlighted keyword. As shown in FIG. 5B, compared with the input audio or video 501, the generated audio or video 503 has subtitles, and in the real-time subtitles 504, “pepper” as a word belonging to a label “seasoning” has been highlighted as a keyword.

Exemplary embodiments of the present disclosure have been described above with reference to FIG. 2 to FIG. 5B. Compared with an existing solution of adding subtitles, in the solution for detecting key segment(s) in an audio or video in the preset disclosure, an automatic processing procedure can be established, to automatically generate subtitles and determine the key segment based on the multi-modal features of the input audio or video, so that it is convenient for the user to add subtitle styles subsequently, thereby effectively reducing labor and time costs. In some implementations, in the solution of the present disclosure, a plurality of recall algorithms may be introduced at the same time to obtain candidate keywords, and a final keyword is further obtained based on label priorities. Therefore, the solution of the present disclosure can have an improved capability of identifying key segments in a video. In some implementations, the keyword frequency condition is further applied to control the keyword frequency in the unit time interval, so that the user can be guided to use differentiated subtitle styles more distinctively, and the richness of the video can be increased.

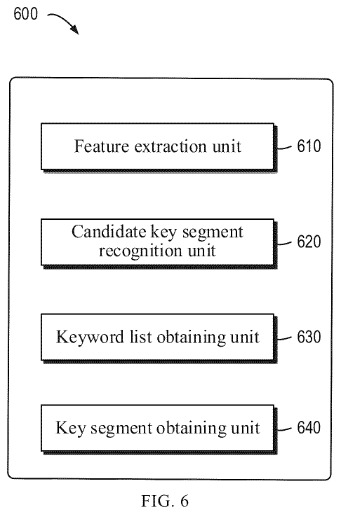

FIG. 6 is a schematic block diagram of an apparatus 600 for determining key segment(s) in an audio or video according to some embodiments of the present disclosure. The apparatus 600 may be implemented at the key segment detector 122 in the computing device 100 shown in FIG. 1. As shown in FIG. 6, the apparatus 600 includes: a feature extraction unit 610, a candidate key segment recognition unit 620, a keyword list obtaining unit 630, and a key segment obtaining unit 640.

In some embodiments, the feature extraction unit 610 is configured to obtain multi-modal features of an audio or video, where the multi-modal features include a visual feature, an acoustic feature, and a natural language feature; the candidate key segment recognition unit 620 is configured to determine candidate key segments in the audio or video based on the multi-modal features; the keyword list obtaining unit 630 is configured to obtain a keyword list based on ASR text of the candidate key segments; and the key segment obtaining unit 640 is configured to determine a key segment in the audio or video based on the keyword list.

It should be noted that more actions or steps shown with reference to FIG. 2 to FIG. 5B may be implemented by the apparatus 600 shown in FIG. 6. For example, the apparatus 600 may include more modules or units to implement the actions or steps described above, or some units or modules shown in FIG. 6 may be further configured to implement the actions or steps described above. Repeated descriptions are not provided herein.

In some embodiments, the methods and processes described above may be implemented as a computer program product. The computer program product may include a computer-readable storage medium on which computer-readable program instructions for performing various aspects of the present disclosure are carried.

The computer-readable storage medium may be a tangible device that can hold and store instructions used by an instruction execution device. The computer-readable storage medium may be, for example, but is not limited to, an electrical storage device, a magnetic storage device, an optical storage device, an electromagnetic storage device, a semiconductor storage device, or any suitable combination thereof. More specific examples of the computer-readable storage medium (a non-exhaustive list) include: a portable computer disk, a hard disk, a random access memory (RAM), a read-only memory (ROM), an erasable programmable read-only memory (EPROM or flash memory), a static random access memory (SRAM), a portable compact disk read-only memory (CD-ROM), a digital versatile disk (DVD), a memory stick, a floppy disk, a mechanical coding device, a punched card or an in-groove raised structure on which instructions are for example stored, and any suitable combination thereof. The computer-readable storage medium used herein is not to be interpreted as a transient signal per se, such as a radio wave or another freely propagating electromagnetic wave, an electromagnetic wave propagating through a waveguide or another transmission medium (e.g., an optical pulse through a fiber-optic cable), or an electrical signal transmitted over a wire.

The computer-readable program instructions described herein may be downloaded from a computer-readable storage medium to each computing/processing device, or downloaded to an external computer or an external storage device over a network, such as the Internet, a local area network, a wide area network, and/or a wireless network. The network may include copper transmission cables, fiber-optic transmission, wireless transmission, routers, firewalls, switches, gateway computers, and/or edge servers. A network adapter card or network interface in each computing/processing device receives computer-readable program instructions from the network and forwards the computer-readable program instructions for storage in the computer-readable storage medium in each computing/processing device.

The computer program instructions for performing the operations of the present disclosure may be assembly instructions, Instruction Set Architecture (ISA) instructions, machine instructions, machine-related instructions, microcode, firmware instructions, status setting data, or source code or object code written in any combination of one or more programming languages, including object-oriented programming languages as well as conventional procedural programming languages. The computer-readable program instructions may be completely executed on a computer of a user, partially executed on a computer of a user, executed as an independent software package, partially executed on a computer of a user and partially executed on a remote computer, or completely executed on a remote computer or server. In a case of the remote computer, the remote computer may be connected to the computer of the user through any kind of network, including a local area network (LAN) or a wide area network (WAN), or may be connected to an external computer (for example, connected through the Internet with the aid of an Internet service provider). In some embodiments, an electronic circuit, such as a programmable logic circuit, a field programmable gate array (FPGA), or a programmable logic array (PLA), is personalized by using state information of the computer-readable program instructions. The electronic circuit may execute the computer-readable program instructions to implement various aspects of the present disclosure.

These computer-readable program instructions may be provided to a processing unit of a general-purpose computer, a special-purpose computer, or another programmable data processing apparatus to produce a machine, such that the instructions, when executed by the processing unit of the computer or the other programmable data processing apparatus, create an apparatus for implementing functions/actions specified in one or more blocks in the flowchart and/or the block diagrams. These computer-readable program instructions may alternatively be stored in the computer-readable storage medium. These instructions enable a computer, a programmable data processing apparatus, and/or another device to work in a specific manner. Therefore, the computer-readable medium storing the instructions includes an artifact that includes instructions for implementing various aspects of functions/actions specified in one or more blocks in the flowchart and/or the block diagrams.

Alternatively, the computer-readable program instructions may be loaded onto a computer, another programmable data processing apparatus, or another device, such that a series of operation steps are performed on the computer, the other programmable data processing apparatus, or the other device to produce a computer-implemented process. Therefore, the instructions executed on the computer, the other programmable data processing apparatus, or the other device implement functions/actions specified in one or more blocks in the flowchart and/or the block diagrams.

The flowcharts and the block diagrams in the accompanying drawings illustrate possible system architectures, functions, and operations of the device, the method, and the computer program product according to a plurality of embodiments of the present disclosure. In this regard, each block in the flowcharts or the block diagrams may represent a part of a module, a program segment, or an instruction. The part of the module, the program segment, or the instruction includes one or more executable instructions for implementing a specified logical function. In some alternative implementations, functions marked in the blocks may occur in a sequence different from that marked in the accompanying drawings. For example, two consecutive blocks may actually be executed substantially in parallel, or may sometimes be executed in a reverse order, depending on a function involved. It should also be noted that each block in the block diagrams and/or the flowcharts, and a combination of the blocks in the block diagrams and/or the flowcharts may be implemented by a dedicated hardware-based system that executes specified functions or actions, or may be implemented by a combination of dedicated hardware and computer instructions.

Various embodiments of the present disclosure have been described above. The foregoing descriptions are exemplary, not exhaustive, and are not limited to the disclosed embodiments. Many modifications and variations are apparent to a person of ordinary skill in the art without departing from the scope and spirit of the described embodiments. The terminology used in this specification is intended to best explain the principles, practical applications, or technical improvements in the market of the embodiments, or to enable others of ordinary skill in the art to understand the embodiments disclosed herein.

I/We claim:

1. A method comprising:
obtaining multi-modal features of an audio or video, wherein the multi-modal features comprise a visual feature, an acoustic feature, and a natural language feature;
determining candidate key segments in the audio or video based on the multi-modal features;
obtaining a keyword list based on automatic speech recognition (ASR) text of the candidate key segments; and
determining a key segment in the audio or video based on the keyword list.

2. The method according to claim 1, wherein determining candidate key segments in the audio or video based on the multi-modal features comprises:
determining a plurality of segments in the audio or video based on the multi-modal features; recognizing ASR text of the plurality of segments; and
obtaining the candidate key segments by filtering out segments without ASR text from the plurality of segments.

3. The method according to claim 2, wherein determining a plurality of segments in the audio or video comprises:
classifying and scoring the multi-modal features; and
determining the plurality of segments in the audio or video in response to scoring results exceeding a threshold.

4. The method according to claim 1, wherein obtaining the keyword list based on the ASR text of the candidate key segments comprises:
obtaining candidate keywords based on the ASR text of the candidate key segments; and
ranking the candidate keywords based on labels of the candidate key segments related to a knowledge graph to obtain the keyword list.

5. The method according to claim 4, wherein obtaining candidate keywords comprises:
recalling the candidate keywords from the ASR text of the candidate key segments, wherein the recalling comprises at least one of the following: model-based recalling; recalling based on vocabulary matching; or recalling based on data pattern matching.

6. The method according to claim 4, wherein ranking the candidate keywords to obtain the keyword list comprises:
ranking the candidate keywords based on the labels of the candidate key segments in which the candidate keywords are located and label priorities; and
obtaining the keyword list from the ranked candidate keywords based on a keyword frequency condition.

7. The method according to claim 6, wherein the keyword frequency condition specifies a maximum allowed number or proportion of keywords in a time interval.

8. The method according to claim 6, wherein the label priorities are determined based on a knowledge graph.

9. The method according to claim 1, wherein obtaining multi-modal features of the audio or video comprises:
obtaining the visual feature of the audio or video from the audio or video through object detection, wherein the visual feature comprises a picture feature of the audio or video.

10. The method according to claim 1, wherein obtaining multi-modal features of the audio or video comprises:
obtaining the acoustic feature from the audio or video through audio event detection, wherein the acoustic feature comprises an audio event.

11. The method according to claim 1, wherein the obtaining multi-modal features of the audio or video comprises:
obtaining the natural language feature from the audio or video based on a knowledge graph and a pre-trained text detection model, wherein the natural language feature comprises ASR text.

12. A device, comprising:
at least one processing unit; and
at least one memory, wherein the at least one memory is coupled to the at least one processing unit and stores instructions executable by the at least one processing unit, and the instructions, when executed by the at least one processing unit, cause the computing device to perform a method comprising:
obtaining multi-modal features of an audio or video, wherein the multi-modal features comprise a visual feature, an acoustic feature, and a natural language feature;
determining candidate key segments in the audio or video based on the multi-modal features;
obtaining a keyword list based on automatic speech recognition (ASR) text of the candidate key segments; and
determining a key segment in the audio or video based on the keyword list.

13. The device according to claim 12, wherein determining candidate key segments in the audio or video based on the multi-modal features comprises:
determining a plurality of segments in the audio or video based on the multi-modal features;
recognizing ASR text of the plurality of segments; and
obtaining the candidate key segments by filtering out segments without ASR text from the plurality of segments.

14. The device according to claim 13, wherein determining a plurality of segments in the audio or video comprises:
classifying and scoring the multi-modal features; and
determining the plurality of segments in the audio or video in response to scoring results exceeding a threshold.

15. The device according to claim 12, wherein obtaining the keyword list based on the ASR text of the candidate key segments comprises:
obtaining candidate keywords based on the ASR text of the candidate key segments; and
ranking the candidate keywords based on labels of the candidate key segments related to a knowledge graph to obtain the keyword list.

16. The device according to claim 15, wherein obtaining candidate keywords comprises:
recalling the candidate keywords from the ASR text of the candidate key segments, wherein the recalling comprises at least one of the following: model-based recalling; recalling based on vocabulary matching; or recalling based on data pattern matching.

17. The device according to claim 15, wherein ranking the candidate keywords to obtain the keyword list comprises:
ranking the candidate keywords based on the labels of the candidate key segments in which the candidate keywords are located and label priorities; and
obtaining the keyword list from the ranked candidate keywords based on a keyword frequency condition.

18. The device according to claim 17, wherein the keyword frequency condition specifies a maximum allowed number or proportion of keywords in a time interval.

19. The device according to claim 17, wherein the label priorities are determined based on a knowledge graph.

20. A non-transitory computer storage medium comprising machine-executable instructions that, when executed by a device, cause the device to perform a method comprising:
obtaining multi-modal features of an audio or video, wherein the multi-modal features comprise a visual feature, an acoustic feature, and a natural language feature;
determining candidate key segments in the audio or video based on the multi-modal features;
obtaining a keyword list based on automatic speech recognition (ASR) text of the candidate key segments; and
determining a key segment in the audio or video based on the keyword list.
